(19) United States
(12) Patent Application Publication
(10) Pub. No.: US 2004/0031361 A1
(43) Pub. Date: Feb. 19, 2004

(54) Cutoff apparatus and die set

(76) Inventors: Brian K. Ricketts, Forrest, IL (US); Ronald E. Hoffman, Bloomington, IL (US)

Correspondence Address: BRINKS HOFER GILSON & LIONE, POST OFFICE BOX 10395, CHICAGO, IL, 60610, US

(21) Appl. No.: 10/367,579

(22) Filed: Feb. 14, 2003

Related U.S. Application Data
(60) Provisional application No. 60/357,279, filed on Feb. 14, 2002.

(51) Int. Cl. B26D 1/00

(52) U.S. Cl. 83/13

(57) ABSTRACT

A cutoff die set for cutting tubing that comprises an upper die section having a cutoff blade, the upper die section being movable in translational reciprocating motion. The cutoff die set also comprises a lower die section having a first jaw guide section and a second jaw guide section. The first jaw guide section and second jaw guide section are operable with each other to secure the tubing during cutting. The lower die section further comprises a scarfing blade. The scarfing blade is operably linked with the upper die section such that movement by the upper die section causes the scarfing blade to move in translational motion to remove a substantially flat surface of the tubing and form an opening. The cutoff blade enters the opening to cut the tubing.

### REFERENCE TO RELATED APPLICATIONS

The present patent document claims the benefit of the filing date under 35 U.S.C. § 119(e) of Provisional U.S. Patent Application Serial No. 60/357,279 filed Feb. 14, 2002 which is incorporated herein in its entirety.

### BACKGROUND

1. Technical Field

The present invention generally relates to a cutoff tool for cutting continuously formed tubing. In particular, the present invention relates to an easily adjustable cutoff tool for notching and shearing non-circular cross section tubing of differing dimensions.

2. Background Information

Typically, in cutoff dies, prenotching is done to tube stock prior to forming the tubing while the tubing material is still in a flat condition. This typically requires additional prenotching equipment. After the tube stock has been formed into tubing an additional scarfing operation is performed on the tubing. After scarfing, the tubing continuously passes through a cutoff die. The cutoff die is movable on rails and temporarily travels at the speed of the tubing in order to cut the tubing with a cutoff blade. One shortcoming of this process is that it is important to precisely align and time the scarfed opening with the cutoff blade while the cutoff blade makes the cut. Failure to precisely align the scarfed opening with the cutting action of the cutoff blade can result in damage to the tubing and cutoff blade. Another shortcoming resulting from this process is that special separate equipment is required to monitor and locate the scarfed opening as it passes through the die. This separate equipment adds cost to the manufacture and operation of the cutoff die. And still another shortcoming resulting from this process is that the tube stock material can stretch during fabrication into tubing. The stretching of the material can distort the prenotch, causing difficulty with locating the prenotch or cutting off the tubing through the scarfed opening.

### BRIEF SUMMARY

The present invention addresses these shortcomings by providing a cutoff die set for non-circular tubing that performs both the scarfing and cutoff operations in a single step in one die set. No prenotching of the tube stock is required or prescarfing of the tubing is required for entry in this die.

In one aspect of the present invention, a cutoff die set for cutting tubing comprises an upper die section having a cutoff blade, the upper die section being movable in translational reciprocating motion. The cutoff die set also comprises a lower die section having a first jaw guide section and a second jaw guide section. The first jaw guide section and second jaw guide section are operable with each other to secure the tubing during cutting. The lower die section further comprises a scarfing blade. The scarfing blade is operably linked with the upper die section such that movement by the upper die section causes the scarfing blade to move in translational motion to remove a substantially flat surface of the tubing and form an opening. The cutoff blade enters the opening to cut the tubing.

In another aspect of the present invention a cutoff die set for cutting tubing comprises a top die shoe being movable in translational reciprocating motion, a cutoff blade connected with the top die shoe, a bottom die shoe, a main die holder connected with the bottom die shoe, a first jaw guide section and a second jaw guide section being operable with each to secure the tubing during cutting, a slide assembly defining a channel; and a scarf arm movable within the channel, the scarf arm being connected with the top die shoe by a connecting arm, and the scarf arm having a scarfing blade. Movement by the top die shoe causes the scarfing blade to move in translational motion to remove a substantially flat surface of the tubing and form an opening and wherein the cutoff blade enters the opening to cut the tubing.

In yet another aspect of the present invention, a scarf arm comprises a scarfing blade defining a blade insert holding notch having at least one recess. The scarf arm further comprises a blade insert removably connected with the scarfing blade. The scarfing blade has a cutting edge and at least one loop for receipt within said at least one recess.

The invention may also be embodied in a method wherein an operator cuts tubing. The cutting operation provides the steps of providing a combination scarf and cutoff apparatus. The apparatus has a scarfing blade with a blade insert and a cutoff blade. The scarfing blade and cutoff blade are mechanically linked-to perform scarfing and cutoff processes in the same cutting operation. The apparatus is used to scarf and cutoff tubing. The cutting operation is then stopped. The blade insert is then removed from the scarfing blade without removing the scarfing blade from the combination scarf and cutoff apparatus. The blade insert is then replaced with a second blade insert. The cutting operation is then resumed.

In another aspect of the present invention a method is embodied for adjusting a combination scarf and cutoff apparatus to accommodate tubing of different dimensions. The combination scarf and cutoff apparatus has a scarfing blade and a cutoff blade wherein the scarfing blade and cutoff blade are mechanically connected with each other by a connecting arm to perform scarfing and cutoff processes in the same cutting operation. The cutting operation for a first tubing is stopped. The scarfing blade is then adjusted to a predetermined height corresponding to a second tubing having dimensions different than the first tubing. The connecting arm is then adjusted to a predetermined length corresponding to a second tubing having dimensions different than the first tubing. The second tubing is then indexed through said scarf and cutoff apparatus and the cutting operation is resumed.

### BRIEF DESCRIPTION OF THE DRAWINGS

FIG. 1 is a perspective view of the cutoff apparatus and die set according to a preferred embodiment of the present invention;

FIG. 2 is a cross-sectional view of the cutoff apparatus and die set according to a preferred embodiment of the present invention during one phase of operation and cutting a tubing of a particular dimension;

FIG. 3 is a cross-sectional view of the cutoff apparatus and die set according to a preferred embodiment of the present invention during another phase of operation and cutting a tubing of a particular dimension;

FIG. 4 is a cross-sectional view of the cutoff apparatus and die set according to a preferred embodiment of the present invention during another phase of operation and cutting a tubing of a particular dimension;

FIG. 5 is a cross-sectional view of the cutoff apparatus and die set according to a preferred embodiment of the present invention during another phase of operation and cutting a tubing of a particular dimension;

FIG. 6 is a plan view of the lower die section according to one embodiment of the present invention;

FIG. 7 is a perspective view of the scarf arm according to a preferred embodiment of the present invention;

FIG. 8 illustrates the angular relationship between the tubing and the cutoff blade and between the tubing and the scarfing blade according to a preferred embodiment of the present invention;

FIG. 9 is a perspective view of the scarfing blade according to a preferred embodiment of the present invention;

FIG. 10 is a perspective view of the connecting arm according to a preferred embodiment of the present invention; and

FIG. 11 is a perspective view of the connecting arm according to another preferred embodiment of the present invention;

### DETAILED DESCRIPTION OF THE DRAWINGS AND PRESENTLY PREFERRED EMBODIMENTS

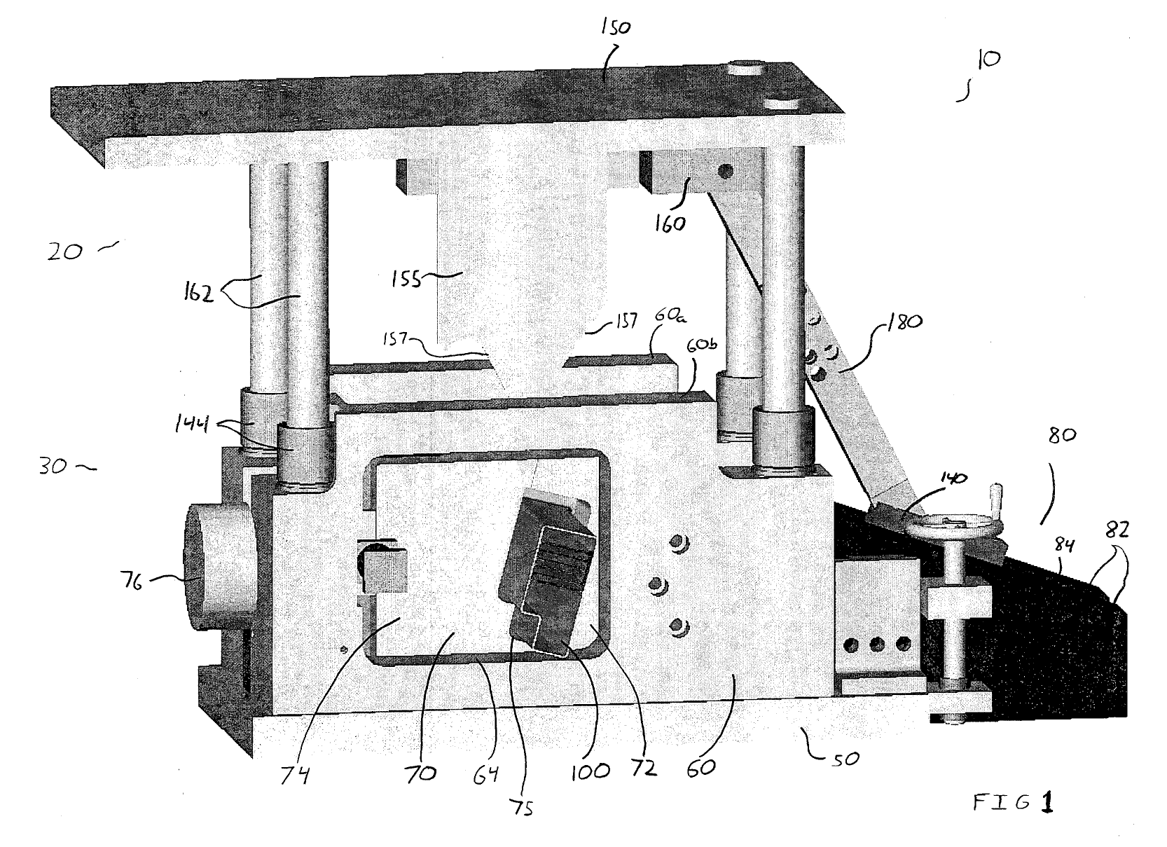

The present invention is used for cutting continuously formed tubing having a non-circular cross section. In a preferred embodiment of the present invention, the cutoff apparatus and die set is used for cutting tubing having a substantially rectangular cross section or for cutting tubing having at least two substantially flat surfaces at an approximately 90° angle from each other. FIG. 1 illustrates an example of such tubing 100 having an “L” shape. The tubing 100 is typically made of commercial grade hot rolled steel, and generally is 0.062 to 0.120 inches thick. Other thicknesses and materials, of course, can be used.

FIGS. 1-4 illustrate a cutoff die set 10 for cutting tubing 100 having a non-circular cross-section. The cutoff die set 10 is mounted in a press. In a preferred embodiment of the present invention, the cutoff die set 10 generally comprises an upper die section 20 and a lower die section 30. The upper die section 20 attaches to the ram of the press and the lower die section 30 is mounted on the bed of the press. The ram of the press moves the upper die section 20 in downward translational reciprocating motion.

The lower die section comprises a bottom die shoe 50 which attaches the lower die section 30 to the bed of the press. The lower die section 30 further comprises a main die holder 60 which is fixedly attached to the bottom die shoe 50. The main die holder 60 comprises two spaced apart ribs 60a, 60b. Each rib has a pass-through opening 64 to allow the tubing 100 to pass axially through the cutoff die set 10.

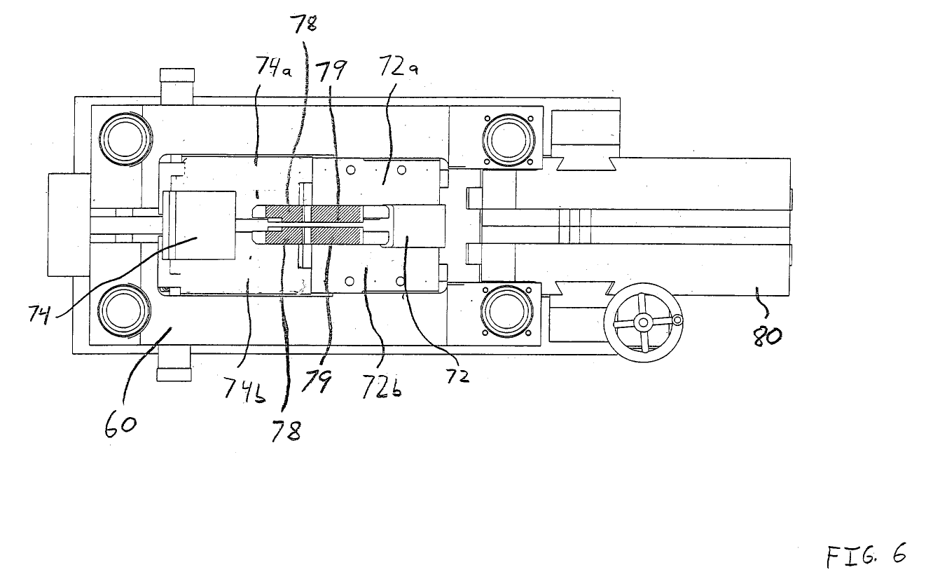

The lower die section 30 further comprises a jaw guide assembly 70. The jaw guide assembly 70 is located between the two ribs 60a, 60b of the main die holder 60 and guides and secures the tubing 100 during the cutoff operation. The jaw guide assembly 70 preferably consists of a fixed first jaw guide 72 and a movable second jaw guide 74. As shown in FIG. 6, the first jaw guide 72 comprises two spaced first jaw guide segments 72a, 72b and the second jaw guide 74 comprises two spaced second jaw guide segments 74a, 74b. The scarfing and cutoff operations (described more fully below) are performed on the tubing 100 between segments 72a, 74a and segments 72b, 74b of the jaw guide assembly 70. The first jaw guide section 72 and the second jaw guide section 74 fit together to form an opening 75 that corresponds to the shape of the tubing 100.

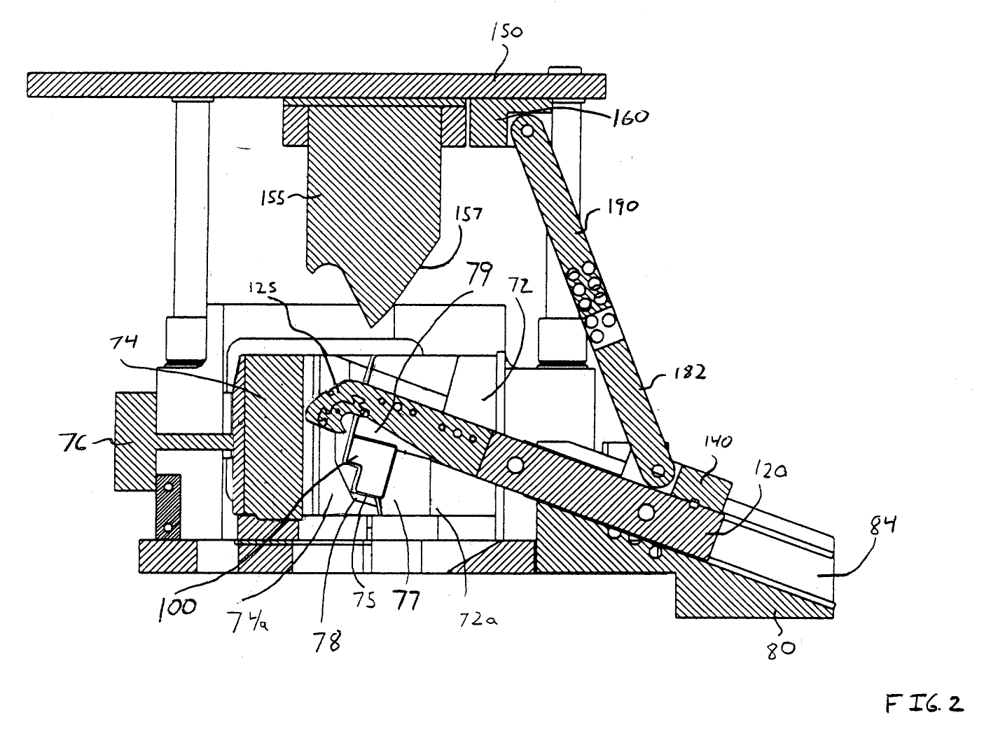

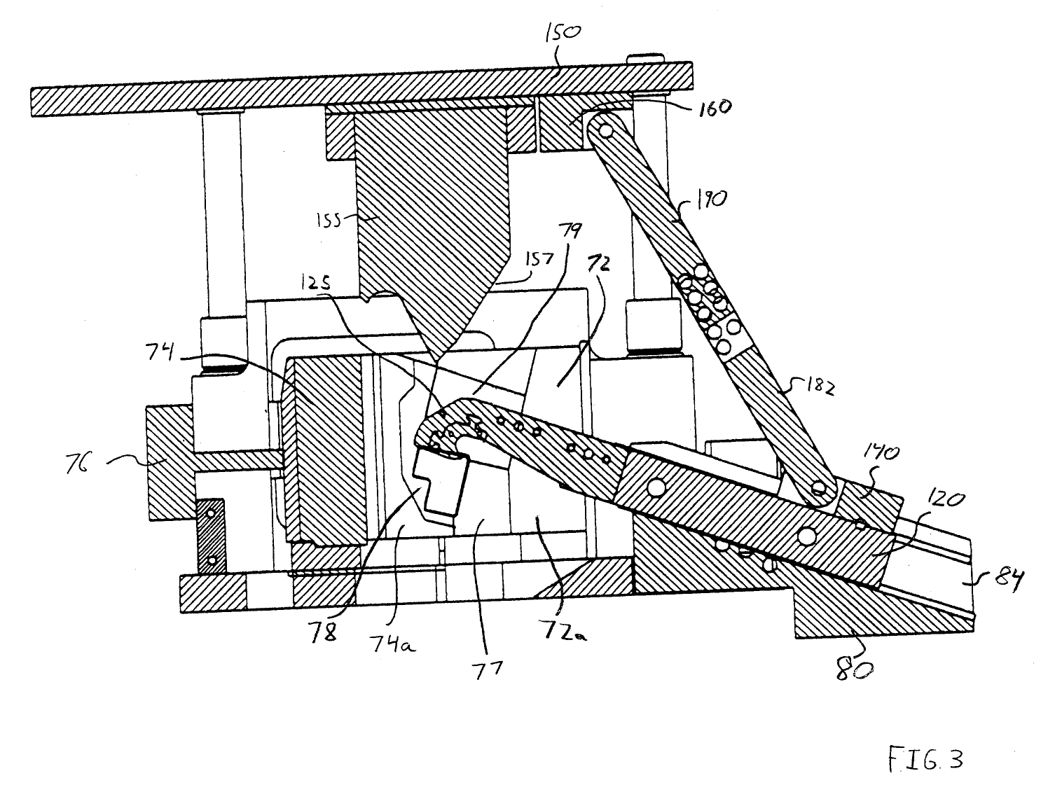

As shown in FIGS. 2-4, The second jaw guide 74 is linearly movable between a first and second position. The second jaw guide section slides along rails attached to the lower die shoe 50. FIG. 2 illustrates the second jaw guide 74 in the first position. In the first position, the second jaw guide 74 is at a distance from the first jaw guide 72 to allow the tubing 100 to pass through the cutoff die set 10. FIGS. 2 and 3 illustrate the second jaw guide 74 in the second position. In the second position, the second jaw guide 74 mates with the first jaw guide section 72 to guide and secure the tubing 100 to provide a shearing edge during the cutting operation. After the cutting operation is completed, the second jaw guide section 74 moves back to the first position. In one embodiment, an actuator 76 is connected with the second jaw guide section 74 to move the second jaw guide section 74 back and forth in translational reciprocating motion. Preferably, the actuator 76 is a hydraulic cylinder.

In another preferred embodiment of the present invention, the jaw guide assembly 70 comprises replaceable guide inserts that are used to guide and secure the tubing 100 to provide a shearing edge during the cutting operation. The guide inserts allow for easy adjustment of the cutoff die set 10 to accommodate different dimensions and configurations of tubing 100. In this embodiment, the guide inserts secure the tubing when the second jaw guide 74 is in the second position. As shown in FIG. 2, a first guide insert 77 is connected with the first jaw guide segment 72a and contacts and supports the tubing 100 at the bottom of the tubing 100. A second guide insert 78 is connected with the second jaw guide segment 74a and contacts and supports the tubing 100 when the second jaw guide 74 moves to its second position. A third guide insert 79, is also connected with the first jaw guide segment 72a and contacts and supports the top of the tubing 100.

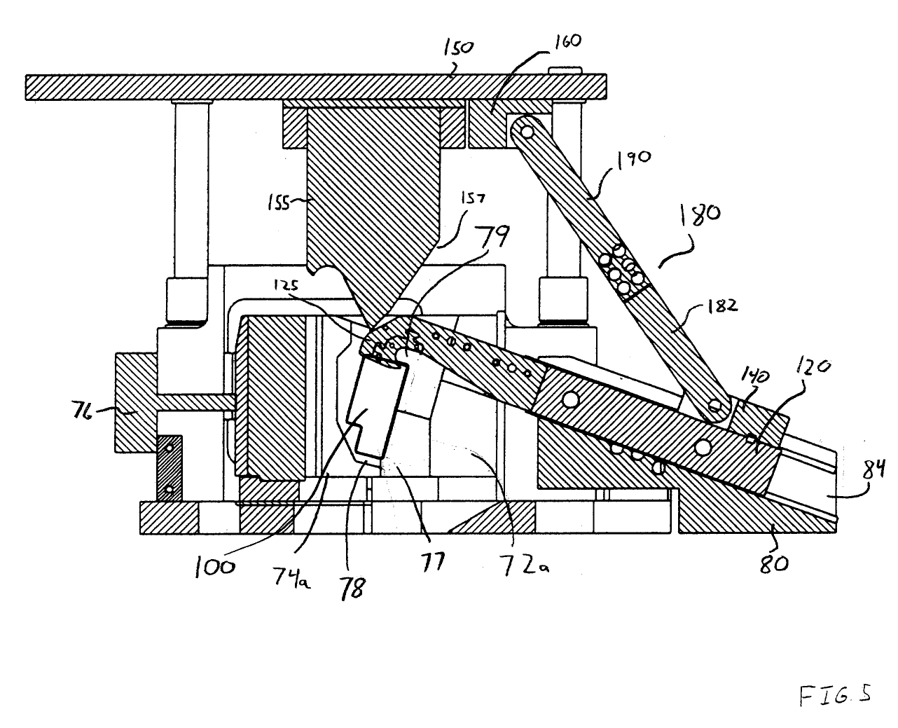

FIGS. 3 and 5 illustrate the different configurations for different third guide inserts corresponding to different dimensions of the tubing 100 being cut. When the cutoff die set 10 needs to be adjusted to accommodate a different dimension tubing, only the third guide insert 79 needs to be replaced in order to accommodate a particular dimension of tubing 100. The third guide insert 79 can be accessed and removed from the top of the lower die section 30, allowing the operator to replace the insert 79 without the need for substantial disassembly of the cutoff die set 10. The cutoff die set 10 has an inventory of multiple third guide inserts 79 with each insert corresponding to a tubing having a particular dimension. Preferably, each insert is of sufficient size to contact the top of a tubing 100 and provide a shearing surface.

The lower die section 30 further comprises a slide assembly 80 attached to the bottom die shoe 50. The slide assembly 80 is movable in a vertical axis relative to the main die holder 60. As shown in FIGS. 3 and 5, the height of the slide assembly 80 can be adjusted to correspond with differing dimensions of tubing 100 to be cut. The slide assembly 80 preferably comprises keeper rails 82 that form a channel 84 in which a scarf arm 120 slides.

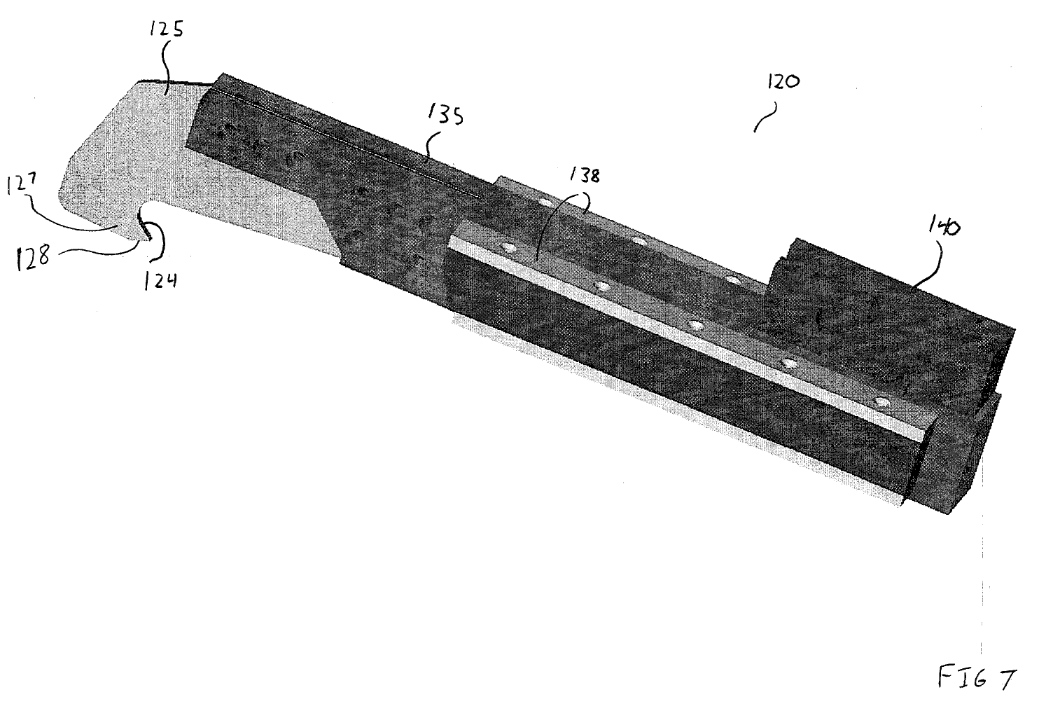

As shown in FIG. 7, the scarf arm 120 preferably comprises a scarfing blade 125, a scarfing blade holder 135, a plurality of wear strips 138, and a lower link block 140. The scarf arm 120 moves in reciprocating motion between the segments of the jaw guide assembly 70 and within the channel 84 of the slide assembly 80 during the cutting operation. The wear strips 138 provide removable wear surfaces for the scarf arm 120 that may be replaced periodically for maintenance. Corresponding wear strips may also be used in the slide assembly 80. The scarfing blade 125 defines a cutting edge 124 that removes a segment of material from the tubing 100 to form a scarfed opening. The scarfing blade further defines a trailing section 127 having a trailing edge 128. The scarfing blade is typically made of tool steel suitable for cutting metal tubing. The trailing section 127 provides strength to the cutting edge 124.

The upper die section 20 comprises a top die shoe 150 that attaches to the ram of the press. The upper die section 20 further comprises a cutoff blade 155 connected with the upper die shoe 150. The cutoff blade 155 defines at least one cutting edge 157. The cutoff blade 155 is positioned such that it can travel translationally into the lower die section 30 in between the segments of the jaw guide assembly 70. The cutoff blade 155 is aligned to enter an opening in the tubing 100 created by the scarfing blade 125. The operations of the cutoff blade 155 and scarfing blade 125 are timed so that the two blades do not contact each other during cutting. The upper die section 20 further comprises an upper link block 160 and guide posts 162. The guide posts 162 extend from the top die shoe 150 into bushings 144 of the lower die section 30. The guide posts 162 and bushings 144 aid in aligning the cutoff blade 155 for the cutting operation.

The upper link block 160 and lower link block 146 connect with each other by a connecting arm 180. Downward motion of the upper link block 160 causes the lower link block 140 to slide within the channel 84 of the slide assembly 80.

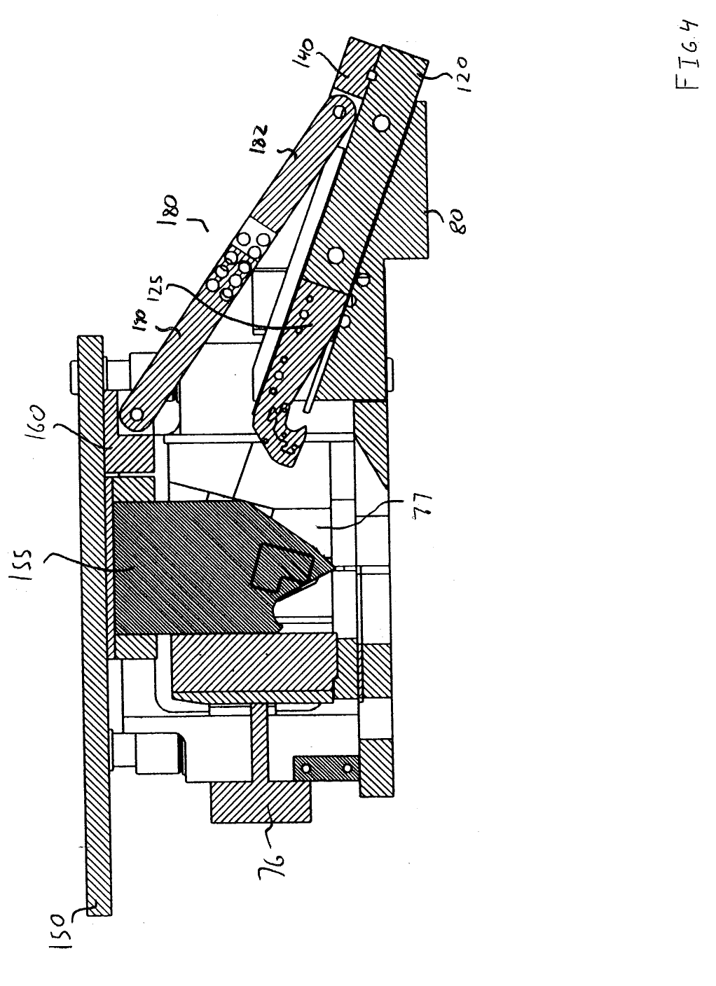

FIGS. 2-4 illustrate three phases of the cutting operation. In operation, the scarfing blade 125 and cutoff blade 155 are used in combination with each other to scarf and cut the tubing 100 in a single step. The tubing 100 is continuously fed through the cutoff die set 10. As illustrated in FIG. 2, the tubing 100 passes through an opening 75 in the jaw guide 70. As illustrated in FIG. 3, when the desired length of tubing 100 has passed through the jaw guide 70, the second jaw guide section 74 moves from its first position to its second position in order to hold the tubing 100. At the same time, the ram of the press lowers the upper die section 20. As the upper die section lowers, the connecting arm 180 causes the scarf arm 120 to move within the channel 84 of the slide assembly 80 so that the lower link block 140 moves away from the tubing 100. The scarfing blade 125 is pulled across the tubing and cuts the tubing 100 at the desired location and depth, removing a substantially flat surface of the tubing. At the same time, the ram lowers the cutoff blade 155, moving it toward the tubing 100. As illustrated in FIG. 4, immediately after the scarfing blade 125 has cut a scarfed opening into the tubing 100, the cutoff blade 155 cuts down through the tubing 100, entering the tubing 100 through the scarfed opening made by the scarfing blade 125. The cutoff blade 155 and the scarfing blade 125 are aligned with each other, however, the two blades are adapted to be mechanically linked together to prevent the blades from contacting each other during the operation. After the cutoff blade 155 has finished cutting the tubing 100, the ram lifts the upper die section 20. The cutoff blade 155 is lifted above the tubing 100 and the scarfing blade 125 is pushed back to its starting position to ready it for the next cut. The second jaw guide section 74 releases the tubing 100 and is moved back to its first position. By having the scarfing blade 125 and the cutoff blade 155 mechanically linked with each other to perform the scarfing and cutoff processes in one cutting operation, it is not necessary to have separate tooling or operations for prenotching and scarfing or to carefully align the cutoff blade with a scarfed opening in the tube stock.

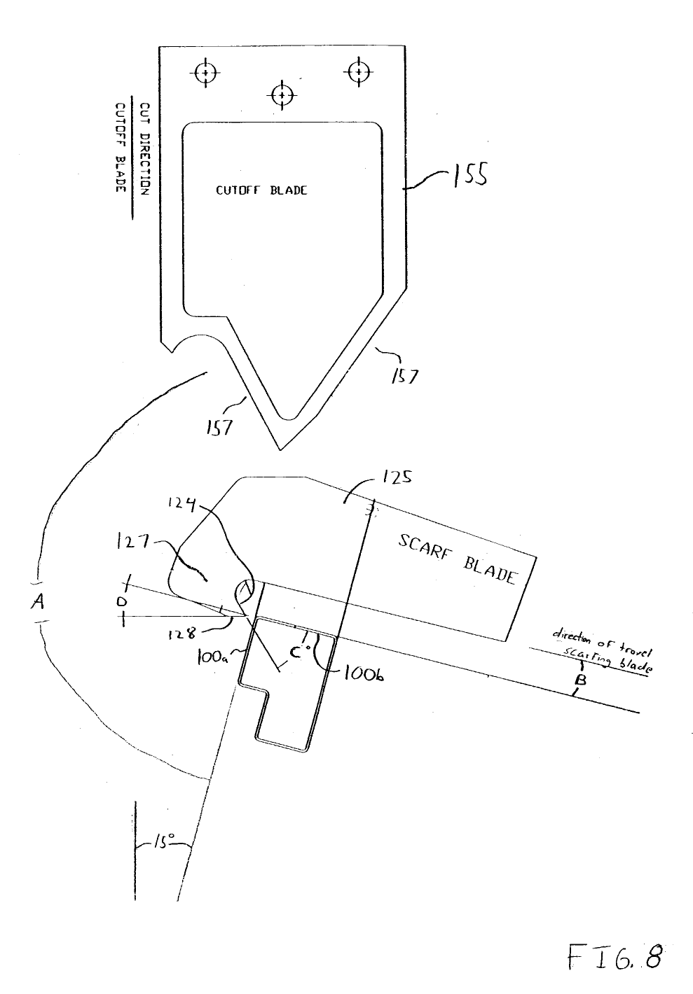

FIG. 8 illustrates an “L” shaped tubing 100 wherein surfaces 100a and 100b are substantially flat surfaces at an approximately 90° angle from each other. During the cutting operation, material is removed from the tubing 100 by the cutoff blade 155. It is important that the removed material is not pushed inside the tubing 100. A buildup of scrap material inside the tubing 100 can damage the cutoff blade 155 and cause wrinkling of the walls. Instead, it is preferable for the material to be pushed by the cutoff blade 155 toward the outside of the tubing 100 and allow the material to fall below the tubing 100. For the material to be pushed to the outside of the tubing 100 by the cutoff blade 155, it is preferable to have the relative angle between the surface of the tubing being cut and the cutting edge 157 of the cutoff blade 155 be at least 45 degrees, and preferably at least 60 degrees. As shown in FIG. 8, the angle between the surface 100b and the cutting edge 157 is represented by angle A. In this embodiment, angle A is 120 degrees. Desired relative angles can be achieved by creating a steep cutting edge 157 angle and/or by rotating the tubing 100 . In the embodiment illustrated in FIG. 8, the tubing has been rotated so that the surface 100a rotated 15 degrees from the direction of travel of the cutoff blade 155.

In a preferred embodiment of the present invention, it is also preferable to orient the direction of travel of the scarfing blade so that the direction of travel is not parallel to the substantially flat surface through which the scarfing blade is cutting. If the direction of travel of the scarfing blade 125 is parallel to the substantially flat surface of the tubing that it is cutting, the removed tubing material tends to bunch-up or otherwise deform as the tubing is cut. It is further preferable for the scarfing blade 125 to remove material from the tubing so that the material does not fall inside of the tubing 100. As illustrated in FIG. 8, the direction of travel of the scarfing blade 125 is rotated at an angle represented by angle B from the surface 100b. This angle is preferably −5 degrees to 5 degrees. An angle above 0 degrees is further preferable because the material being removed by the scarfing blade 125 is pulled away from the inside of the tubing 100. In FIG. 8, the angle between the cutting edge 124 and the surface 100b is represented by angle C. Angle C is preferably in the range of 40 degrees to 50 degrees and most preferably is 45 degrees. The angle between the trailing edge 128 and the surface 100b is represented by angle D. Angle D is preferably in the range of 0 degrees to 15 degrees and most preferably is 7.5 degrees. As angle D increases, the size of the trailing section 127 also increases, providing greater support for the cutting edge 124. A larger angle D, however, also potentially causes the trailing edge 128 to deform the tubing 100 as it is pulled through the scarfed opening created by the cutting edge 124.

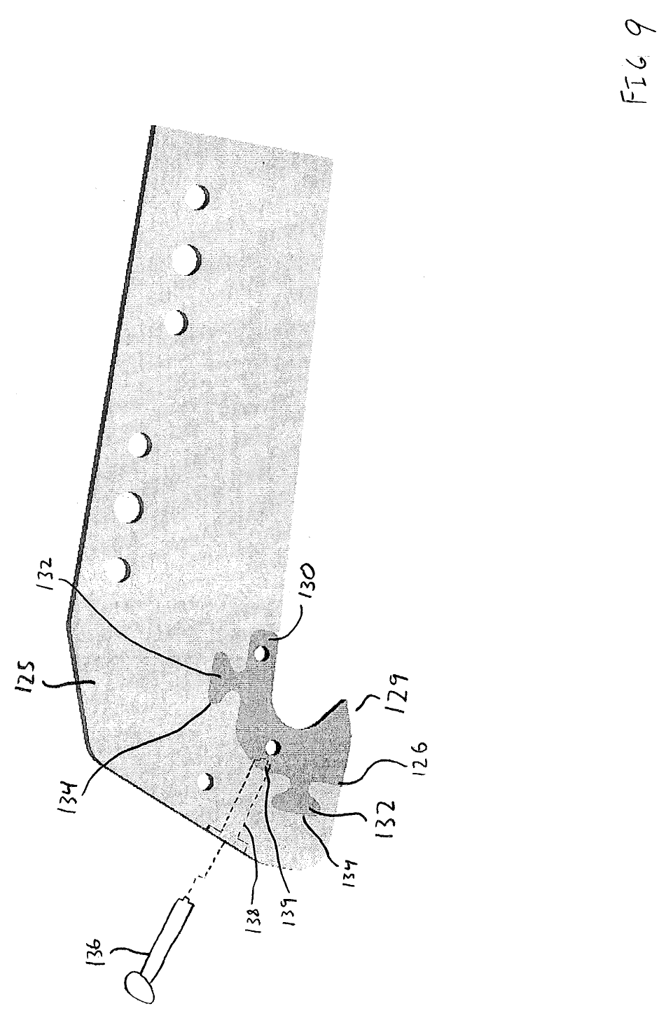

In another preferred embodiment of the scarf arm 120, FIG. 9. illustrates a scarfing blade 125 that contains a replaceable insert 130. The scarfing blade 125 is typically fabricated from tool steel that is a relatively expensive and brittle material. It is common for prior art one-piece scarfing blades to be damaged and break during operation. After a breakage, the entire scarfing blade must typically be removed from the tool and replaced. This can be expensive both in terms of cost of replacing the entire scarfing blade and in down time for the tool as the scarf arm 120 is disassembled and reassembled during replacement.

In the embodiment illustrated in FIG. 9, the hook portion 129 of the scarfing blade 125 is a replaceable insert 130 made of the more expensive and relatively brittle tool steel. The insert 130 defines a cutting edge 131 for removing material from the tubing 100. The scarfing blade 125 is made of a relatively less expensive but more shock resistant and durable material. The scarfing blade 125 defines a blade insert holding notch 126 for holding the blade insert 130. If the hook portion 129 of the scarfing blade 125 is damaged and needs to be replaced, the operator need only replace the insert 130 itself without disassembly of the scarf arm 120 or removal of the scarfing blade 125 from the cutoff die set 10. Preferably, the scarfing blade insert 130 is held in place by one or more loops 132 that mate with corresponding recesses 134 on the scarfing blade 125. The loops 132 of the insert 130 are placed into the recesses 134 of the blade insert holding notch 126 so that the insert 130 is mechanically restrained from being pulled out of the scarfing blade 125 during the cutting operation. Preferably, a set pin 136 is also used to prevent lateral motion of the insert 130. In this embodiment, the set pin 136 is inserted into corresponding holes 138, 139 in the scarfing blade 125 and insert 130 to prevent lateral motion of the insert 130 during the cutting operation. This design allows for convenient replacement of the insert because only the set pin 136 needs to be removed to allow the user to remove and replace the insert 130. Preferably, the insert 130 is coated with a high-chrome diamond coating which increases hardness, increases temperature resistance, improves corrosion resistance reduces friction, and prevents galling.

According to another embodiment of the present invention, connecting arm 180 can be quickly and easily adjusted to allow the die set 10 to accommodate tubing 100 of different dimensions. Comparing figures FIGS. 3 and 5, the tubing dimensions that the cutoff die set 10 can accommodate can be generally of the same shape, however, have different dimensions. With each different tubing 100, the scarfing blade 125 must be adjusted to a corresponding height. As mentioned above, the slide assembly 80 is movable in a vertical axis relative to the main die holder 60. This allows an operator to adjust the height of the scarf arm assembly 120 to a predetermined corresponding height for a particular tubing 100 by adjusting the height of the slide assembly 80. FIG. 3 illustrates the slide assembly 80 in a relatively lowered position for cutting a smaller tubing 100, whereas, FIG. 5 illustrates the slide assembly 80 in a relatively raised position for cutting a larger tubing 100. When the height of the slide assembly 80 changes, the distance between the slide assembly 80 and the upper die section 20 changes. As a result, the length of the connecting arm 180 must also be changed for each height adjustment of the scarfing blade 125.

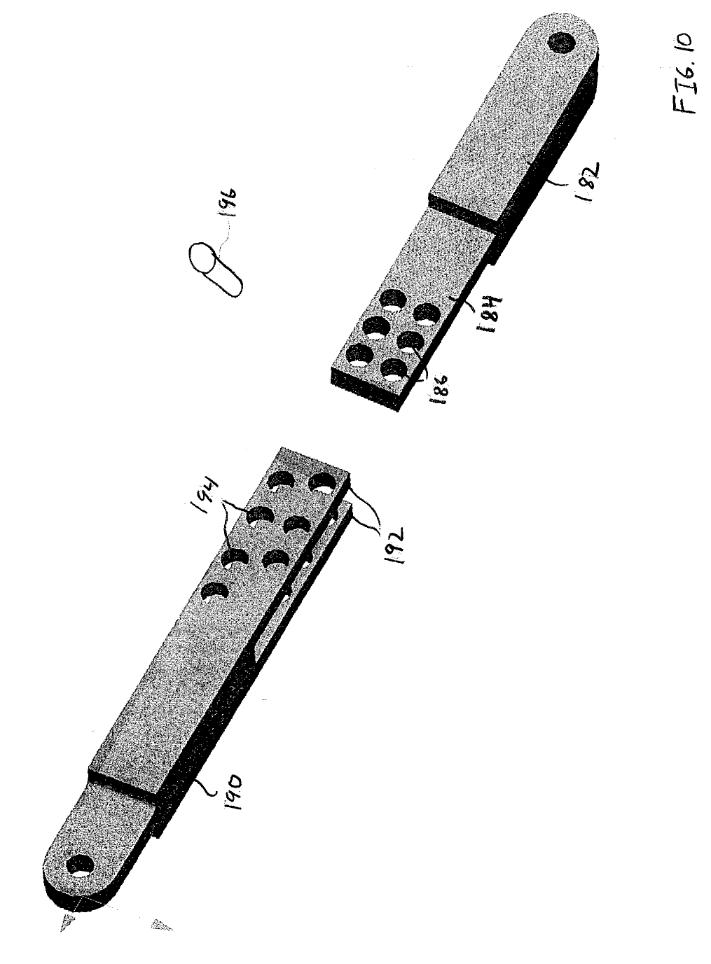

FIG. 10 illustrates one preferred embodiment of an adjustable connecting arm 180. In this preferred embodiment, the connecting arm comprises a lower connecting arm 182 and an upper connecting arm 190. The upper connecting arm 190 contains two spaced supports 192 that form a channel. A plurality of aligned and spaced holes 194 are located on the spaced supports 192. The lower connecting arm 182 has a tongue 184 that is adapted to fit between the spaced supports 192 of the upper connecting arm 190. A plurality of holes 186 are located on the tongue 184. A predetermined length of the connecting arm assembly 180 is required to correspond to the desired scarf blade 125 height. The length of the connecting arm assembly can be modified by aligning desired holes 186 of the lower connecting arm 182 with desired holes 194 of the upper connecting arm 190 and placing a removable pin 196 through the desired holes of the upper and lower connecting arms, thereby linking the upper and lower connecting arms and establishing a desired length of the connecting arm 180. FIGS. 3 and 5 illustrate differences in lengths of the connecting arm 180 for different dimensions of tubing. FIG. 3 illustrates a relatively long connecting arm 180 for cutting a smaller tubing 100, whereas, FIG. 5 illustrates a relatively short connecting arm 180 for cutting a larger tubing 100.

In this embodiment, the operator may easily adjust the cutoff die set 10 to accommodate tubing of different dimensions. When the cutoff die set 10 needs to be adjusted to accommodate a particular tubing, the operator first stops the cutoff operation for an existing tubing. The operator then removes the removable pin 196 so that the upper connecting arm 190 and the lower connecting arm 182 are no longer connected with each other. The operator then adjusts the height of the scarfing blade 125 to a predetermined height that corresponds to the dimensions of the new tubing 100 being cut. The height of the scarfing blade 125 is adjusted by adjusting the height of the slide assembly 80 to a predetermined height that also corresponds to the dimensions of the new tubing 100 being cut. The upper connecting arm 190 and the lower connecting arm 182 are then positioned so that predetermined holes on the upper connecting arm 190 and on the lower connecting arm 182 are aligned. The location of the predetermined holes also corresponds to the dimensions of the new tubing 100 being cut. The operator then inserts the removable pin 196 into the predetermined holes. The operator also removes the third guide insert 79 corresponding to the existing tubing 100 and installs a new third guide insert 79 that corresponds to the dimensions of the new tubing 100 being cut. The new tubing is indexed through the cutoff die 10 set and the cutting operation resumes.

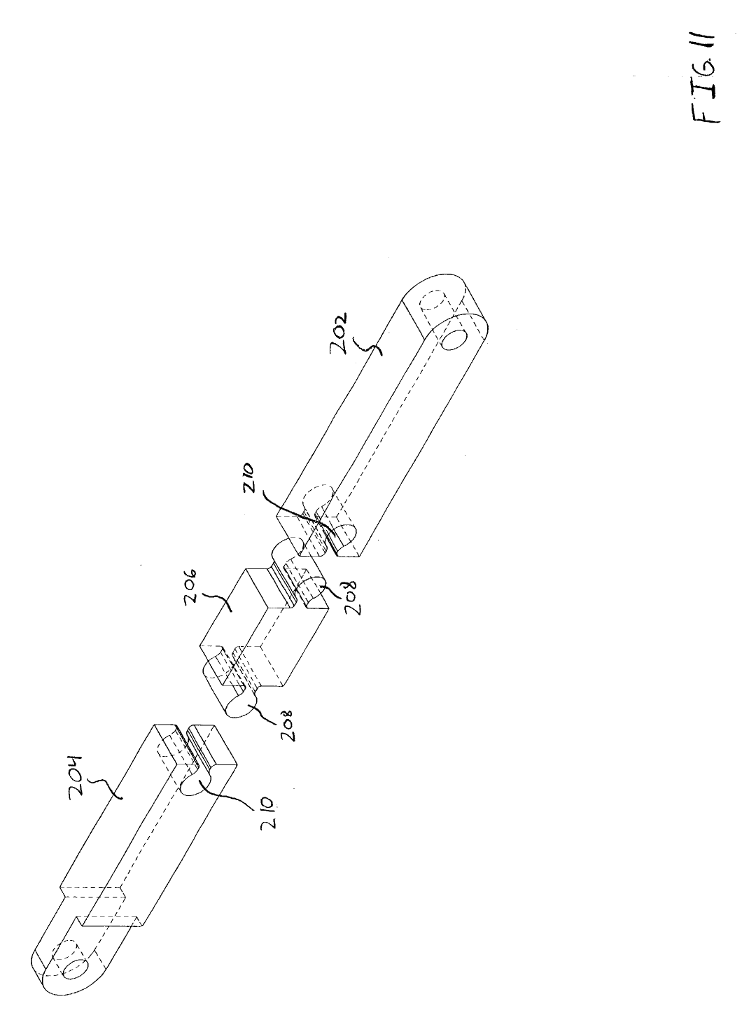

In another preferred embodiment of the connecting arm 180, the connecting arm comprises a lower connecting arm 202, an upper connecting arm 204, and a spacer 206. As shown in FIG. 11, the spacer contains two loops 208 at opposite ends. The ends of lower connecting arm 202 and upper connecting arm 204 have corresponding recesses 210 that mate with a loop 208 of the spacer. Modification of the length of the connecting arm 180 is achieved by inserting spacers 206 of varying lengths between the upper connecting arm 204 and the lower connecting arm 202.

It is therefore intended that the foregoing detailed description be regarded as illustrative rather than limiting, and that it be understood that it is the following claims, including all equivalents, that are intended to define the spirit and scope of this invention.

We claim:

1. A cutoff die set for cutting tubing comprising:
an upper die section having a cutoff blade, the upper die section being movable in translational reciprocating motion; and
a lower die section having a first, jaw guide section and a second jaw guide section, the first jaw guide section and second jaw guide section being operable with each other to secure the tubing during cutting, the lower die section further comprising a scarfing blade;
wherein the scarfing blade is operably linked with the upper die section such that movement by the upper die section causes the scarfing blade to move in translational motion to remove a substantially flat surface of the tubing and form an opening, and wherein the cutoff blade enters the opening to cut the tubing.

2. The cutoff die set of claim 1 further comprising a connecting arm that connects the upper die section with the scarfing blade, said connecting arm causes the scarfing blade to move in translational motion in response to movement of the upper die section.

3. The cutoff die set of claim 2 wherein the connecting arm is operably adjustable to a plurality of predetermined lengths wherein each length corresponds to a different dimension of tubing.

4. The cutoff die set of claim 1 wherein the direction of travel of the scarfing blade is not parallel to the substantially flat surface of the tubing.

5. The cutoff die set of claim 4 wherein the direction of travel of the scarfing blade is at an angle from the substantially flat surface of the tubing, said angle being in the range of above 0 degrees through 5 degrees.

6. The cutoff die set of claim 1 the scarfing blade further comprises a blade insert positioned within a blade insert holding notch having at least one recess, the blade insert removably connected with the scarfing blade, said blade insert having a cutting edge and at least one loop for receipt into said at least one recess.

7. The cutoff die set of claim 1 wherein the first jaw guide section is fixed and the second jaw guide section is movable between a first position and a second position.

8. A cutoff die set for cutting tubing comprising:
a top die shoe being movable in translational reciprocating motion;
a cutoff blade connected with the top die shoe;
a bottom die shoe,
a main die holder connected with the bottom die shoe,
a first jaw guide section and a second jaw guide section being operable with each to secure the tubing during cutting,
a slide assembly defining a channel; and
a scarf arm movable within the channel, the scarf arm being connected with the top die shoe by a connecting arm, and the scarf arm having a scarfing blade;
wherein movement by the top die shoe causes the scarfing blade to move in translational motion to remove a substantially flat surface of the tubing and form an opening and wherein the cutoff blade enters the opening to cut the tubing.

9. The cutoff die set of claim 8 wherein the connecting arm is operably adjustable to a plurality of predetermined lengths wherein each length corresponds to a different dimension of tubing.

10. The cutoff die set of claim 8 wherein the direction of travel of the scarfing blade is not parallel to the substantially flat surface of the tubing.

11. The cutoff die set of claim 10 wherein the direction of travel of the scarfing blade is at an angle from the substantially flat surface of the tubing, said angle being in the range of above 0 degrees through 5 degrees.

12. The cutoff die set of claim 8 wherein the scarfing blade further comprises a blade insert positioned within a blade insert holding notch having at least one recess, the blade insert removably connected with the scarfing blade, said blade insert having a cutting edge and at least one loop for receipt into said at least one recess.

13. The cutoff die set of claim 8 wherein the slide assembly is operably adjustable in response to differing dimensions of tubing.

14. The cutoff die set of claim 9 wherein the connecting arm comprises a lower connecting arm, an upper connecting arm, and a removable pin, the lower connecting arm having two spaced supports that form a channel, the supports having a plurality of holes, the upper connecting arm having a tongue, the tongue having a plurality of holes, the removable pin adapted to fit within said holes for connecting the upper connecting arm and lower connecting arm to establish a predetermined length for the connecting arm in response to differing dimensions of tubing.

15. The cutoff die set of claim 9 wherein the connecting arm comprises a lower connecting arm, an upper connecting arm, and a plurality of spacers for connecting the lower connecting arm with the upper connecting arm, wherein each spacer is of a predetermined length to make the connecting arm of a length that corresponds to a particular dimensions of tubing being cut.

16. The cutoff die set of claim 8 wherein the first jaw guide section is fixed and the second jaw guide section is movable between a first position and a second position.

17. The cutoff die set of claim 16 wherein a hydraulic cylinder moves the second jaw guide section between a first position and a second position.

18. A scarf arm comprising:
a scarfing blade defining a blade insert holding notch having at least one recess; and
a blade insert removably connected with the scarfing blade, said scarfing blade having a cutting edge and at least one loop for receipt within said at least one recess.

19. The scarf arm of claim 18 further comprising a set pin wherein the scarfing blade and blade insert define aligned holes for receiving said set pin.

20. A method for cutting tubing comprising the steps of:
providing a combination scarf and cutoff apparatus, said apparatus having a scarfing blade with a blade insert and cutoff blade, wherein the scarfing blade and cutoff blade are mechanically linked to perform scarfing and cutoff processes in the same cutting operation;
using said apparatus to scarf and cutoff tubing;
stopping said cutting operation;
removing said blade insert from said scarfing blade without removing the scarfing blade from the combination scarf and cutoff apparatus;
replacing said blade insert with a second blade insert; and
resuming said cutting operation.

21. A method for adjusting a combination scarf and cutoff apparatus to accommodate tubing of different dimensions comprising the steps of:
providing a combination scarf and cutoff apparatus, said apparatus having a scarfing blade and cutoff blade, wherein the scarfing blade and cutoff blade are mechanically connected with each other by a connecting arm to perform scarfing and cutoff processes in the same cutting operation;
stopping the cutting operation for a first tubing;
adjusting the scarfing blade to a predetermined height corresponding to a second tubing having dimensions different than the first tubing;
adjusting the connecting arm to a predetermined length corresponding to a second tubing having dimensions different than the first tubing;
indexing said second tubing through said scarf and cutoff apparatus; and
resuming said cutting operation.
